(19) United States
(12) Patent Application Publication
(10) Pub. No.: US 2009/0271049 A1
(43) Pub. Date: Oct. 29, 2009

(54) ASSURING STABILITY OF THE SPEED OF A COOLING FAN IN A COMPUTER SYSTEM

(75) Inventors: Charles E. Kinney, La Jolla, CA (US); Aleksey M. Urmanov, San Diego, CA (US); Kenny C. Gross, La Jolla, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/109,561

(22) Filed: Apr. 25, 2008

(51) Int. Cl. G05D 23/19; G06F 1/20; G06N 5/02

(52) U.S. Cl. 700/300; 706/46

(57) ABSTRACT

Some embodiments of the present invention provide a system that assures stability of the speed of a cooling fan in a computer system. During operation, a temperature of the computer system, an ambient temperature, and a current fan speed for the cooling fan are monitored. Next, a validated ambient temperature based on parameters including the temperature of the computer system, the ambient temperature, and the current fan speed is computed. Then, a control signal is generated in response to the validated ambient temperature, and the control signal is sent to the cooling fan to assure stability of the fan speed of the cooling fan.

### BACKGROUND

1. Field

The present invention relates to techniques for enhancing the performance of computer systems. More specifically, the present invention relates to a method and apparatus for assuring stability of the speed of a cooling fan in a computer system.

2. Related Art

Processors in computer systems generate heat during operation and are typically actively cooled using fans. An efficient fan-control system often uses a feedback technique that monitors both the temperature of the processor and the ambient temperature, and sets the fan speed based on the difference between these two temperatures.

The ambient temperature sensor for computer systems is typically located inside the computer system case so that the sensor is protected from physical damage during handling, installation, and routine use. As a result of this ambient temperature sensor placement, the sensor may heat up as the computer heats up. Thus, when the cooling fan speed is changed, altering the flow of air into the computer case, the temperature inside the case, and consequently the temperature sensed by the ambient temperature sensor, will be affected.

For example, when a processor heats up, the difference between the ambient temperature and the processor temperature increases and the fan controller sets the fan speed to a higher level to increase the cooling power of the fan. The increased fan speed draws more cool air into the computer case, cooling the ambient temperature sensor, and causing bias that can result in the fan speed being forced into oscillations by the fan controller.

Oscillations in fan speed can harm a processor by generating internal thermal cycles and gradients in the processor which can accelerate multiple reliability physics degradation modes. Additionally, fan speed oscillations can increase the vibrational energy transmitted to the processor which can accelerate additional failure mechanisms.

Hence, what is needed is a method and apparatus for assuring stability of the speed of a cooling fan in a computer system without the above-described problems.

### SUMMARY

Some embodiments of the present invention provide a system that assures stability of the speed of each of one or more cooling fans in a computer system. During operation of the computer system, one or more temperatures of the computer system, an ambient temperature, and a current fan speed for each of one or more cooling fans is monitored. Next, a validated ambient temperature is computed based on parameters including the one or more temperatures of the computer system, the ambient temperature, and the current fan speed for each of one or more cooling fans. Then, a control signal is generated in response to the validated ambient temperature, and the control signal is sent to each of the one or more cooling fans to assure stability of the speed for each of the one or more cooling fan.

In some embodiments, computing the validated ambient temperature includes computing the validated ambient temperature based on parameters including a time series of the one or more temperatures of the computer system, and a time series of the ambient temperature.

In some embodiments, monitoring the one or more temperatures of the computer system, the ambient temperature, and the current fan speed for each of the one or more cooling fans includes systematically monitoring and recording a set of performance parameters of the computer system, wherein the recording process keeps track of the temporal relationships between events in different performance parameters.

In some embodiments, computing the validated ambient temperature includes using a pattern-recognition technique.

In some embodiments, computing the validated ambient temperature includes using a nonlinear nonparametric regression technique.

In some embodiments, computing the validated ambient temperature includes using a multivariate state estimation technique.

Some embodiments additionally compute one or more validated temperatures of the computer system based on parameters including the one or more temperatures of the computer system, the ambient temperature, and the current fan speed for each of the one or more cooling fans, wherein generating the control signal includes generating the control signal in response to the one or more validated temperatures of the computer system.

In some embodiments, generating the control signal includes using a multiple input multiple output controller.

In some embodiments, generating the control signal includes using a dead-zone controller.

In some embodiments, generating the control signal includes generating the control signal in response to the current fan speed for each of the one or more cooling fans.

In some embodiments, generating the control signal includes generating a fan speed change signal for each of the one or more cooling fans based on parameters including the current fan speed for each of the one or more cooling fans.

### BRIEF DESCRIPTION OF THE FIGURES

FIG. 1 represents a system that assures stability of the speed of a cooling fan in a computer system in accordance with some embodiments of the present invention.

FIG. 2 presents a flowchart illustrating a process that assures stability of the speed of a cooling fan in a computer system in accordance with some embodiments of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

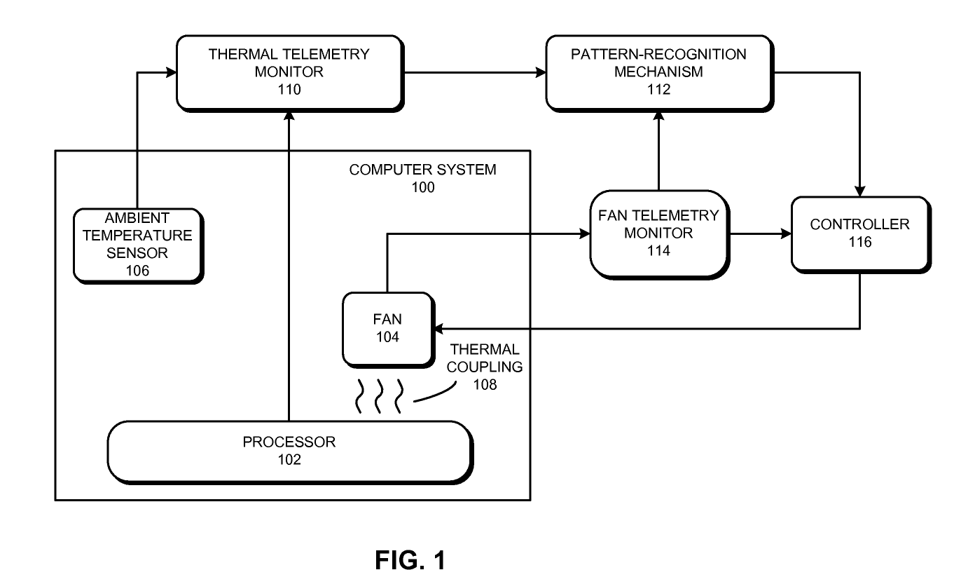

FIG. 1 represents a system that assures stability of the speed of a cooling fan in a computer system in accordance with some embodiments of the present invention. Computer system 100 includes processor 102, fan 104, and ambient temperature sensor 106. Fan 104 and processor 102 are coupled by thermal coupling 108.

Processor 102 can generally include any type of processor, including, but not limited to, a microprocessor, a mainframe computer, a digital signal processor, a personal organizer, a device controller, a computational engine within an appliance, and any other processor now known or later developed. Furthermore, processor 102 can include one or more cores.

Note that although FIG. 1 illustrates computer system 100 with one processor, computer system 100 can include more than one processor. In a multi-processor configuration, the processors can be located on a single system board, or multiple system boards. Computer system 100 can include but is not limited to a server, server blade, a datacenter server, or an enterprise computer.

Processor 102 and ambient temperature sensor 106 are coupled to thermal telemetry monitor 110, and thermal telemetry monitor 110 is coupled to pattern-recognition mechanism 112. Fan 104 is coupled to fan telemetry monitor 114, and fan telemetry monitor 114 is coupled to pattern-recognition mechanism 112. Pattern-recognition mechanism 112 is coupled to controller 116, and controller 116 is coupled to fan 104.

Fan 104 can include any type of fan that can be controlled by controller 116 and used to cool processor 102, and it can be implemented in any technology now known or later developed. In some embodiments, fan 104 can be replaced by multiple fans.

Thermal telemetry monitor 110 can include any device that can receive a thermal telemetry signal and can be implemented in any combination of hardware and software. In some embodiments, thermal telemetry monitor 110 operates on processor 102. In other embodiments, thermal telemetry monitor 110 operates on one or more service processors. In still other embodiments, thermal telemetry monitor 110 is located inside of computer system 100. In yet other embodiments, thermal telemetry monitor 110 operates on a separate computer system.

In some embodiments thermal telemetry monitor 110 includes a method or apparatus for monitoring and recording computer system performance parameters as set forth in U.S. Pat. No. 7,020,802 which is hereby fully incorporated by reference.

Fan telemetry monitor 114 can include any device that can receive a fan telemetry signal and can be implemented in any combination of hardware and software. In some embodiments, fan telemetry monitor 114 operates on processor 102. In other embodiments, fan telemetry monitor 114 operates on one or more service processors. In still other embodiments, fan telemetry monitor 114 is located inside of computer system 100. In yet other embodiments, fan telemetry monitor 114 operates on a separate computer system. In still other embodiments, fan telemetry monitor 114 and thermal telemetry monitor 110 operate on the same hardware. In some embodiments, fan telemetry monitor 114 includes a method or apparatus for monitoring and recording computer system performance parameters as set forth in U.S. Pat. No. 7,020,802.

Pattern-recognition mechanism 112 can include any device that can receive input from thermal telemetry monitor 110 and fan telemetry monitor 114, and recognize a pattern based on the received input. Moreover, pattern-recognition mechanism 112 can be implemented in any combination of hardware and software. In some embodiments, pattern-recognition mechanism 112 operates on processor 102. In other embodiments, pattern-recognition mechanism 112 operates on one or more service processors. In still other embodiments, pattern-recognition mechanism 112 is located inside computer system 100. In yet other embodiments, pattern-recognition mechanism 112 operates on a separate computer system. In still other embodiments, pattern-recognition mechanism 112, fan telemetry monitor 114, and thermal telemetry monitor 110 operate on the same hardware. In some embodiments, pattern-recognition mechanism 112 includes a mechanism implementing a nonlinear nonparametric regression technique, and in other embodiments pattern-recognition mechanism 112 includes a mechanism implementing a multivariate state estimation technique as referred to and described in a U.S. patent application entitled “Method and Apparatus for Determining Whether Components are not Present in a Computer System,” Ser. No. 11/964,540 filed on Dec. 26, 2007 which is hereby fully incorporated by reference.

Controller 116 can include any device that can receive input from pattern-recognition system 112 and from fan telemetry monitor 114, and send output to fan 104. In some embodiments, controller 116 operates on processor 102. In other embodiments, controller 116 operates on one or more service processors, and in still other embodiments, controller 116 is located inside of computer system 100. In yet other embodiments controller 116 operates on a separate computer system. In still other embodiments, pattern-recognition mechanism 112 and controller 116 operate on the same hardware. In some embodiments, controller 116 includes a multiple input multiple output controller, and in other embodiments controller 116 includes a dead-zone controller. In one embodiment of the dead-zone controller, when the processor temperature is within a predefined temperature range, the controller does not alter the fan speed. In other embodiments, controller 116 includes a controller that controls the fan speed based on current and past processor temperature values.

It is noted that in some embodiments, thermal telemetry monitor 110 receives temperature information from, and fan 104 is thermally coupled to, portions of computer system 100 other than processor 102, including but not limited to any system, sub-system, component, device, or other physical or logical segments within computer system 100 or any combination thereof, or the entire computer system. For example, in some embodiments, thermal telemetry monitor 110 receives temperature information from, and fan 104 is thermally coupled to, a power supply or memory chip in the computer system.

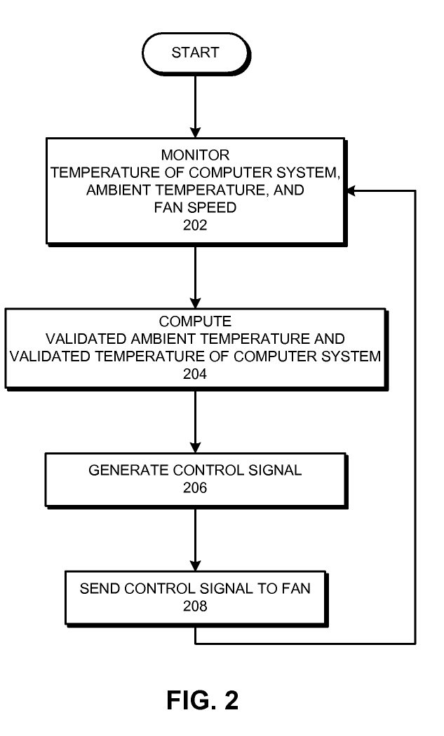

FIG. 2 presents a flowchart illustrating a process that assures stability of the speed of a cooling fan in a computer system in accordance with some embodiments of the present invention. First, the temperature of the computer system, the ambient temperature, and the speed of the fan are monitored (step 202). Next, the validated ambient temperature and the validated temperature of the computer system are computed based on parameters including the temperature of the computer system, the ambient temperature and the fan speed (step 204). Then, a control signal is generated in response to the validated ambient temperature, the validated temperature of the computer system, and the fan speed (step 206). Next, the control signal is sent to the fan to assure stability of the fan speed (step 208). The process then returns to step 202.

More specifically, during operation of some embodiments, thermal telemetry monitor 110 receives a signal from processor 102 representing the temperature of processor 102, and receives a signal from ambient temperature sensor 106 representing the temperature sensed by ambient temperature sensor 106. Similarly, fan telemetry monitor 114 receives a signal from fan 104 representing the speed of fan 104.

Thermal telemetry monitor 110 then sends a signal to pattern-recognition mechanism 112 representing the temperature signals received. In some embodiments thermal telemetry monitor 110 sends a signal to pattern-recognition mechanism 112 representing a time series of the temperature signals received from processor 102 and ambient temperature sensor 106.

Fan telemetry monitor 114 similarly sends a signal to pattern-recognition mechanism 112 representing the fan speed signals received. In some embodiments, fan telemetry monitor 114 sends a signal to pattern-recognition mechanism 112 representing a time series of fan speed signals received from fan 104.

In some embodiments the signals sent to pattern-recognition mechanism 112 include information related to the temporal relationship between one or more of the temperature signals from processor 102, the temperature signals from ambient temperature sensor 106, and fan speed signals from fan 104.

Pattern-recognition mechanism 112 then generates a validated ambient temperature from the received inputs. In some embodiments, pattern-recognition mechanism 112 includes information generated by training pattern-recognition mechanism 112. In some embodiments, the information generated by training is generated during a training process in which pattern-recognition mechanism 112 includes an input from a temperature sensor located outside of computer system 100, while in other embodiments the temperature outside of computer system 100 is held at a known constant value. Using the temperature information from outside of computer system 100, pattern-recognition mechanism 112 is trained to generate the validated ambient temperature based on input from thermal telemetry monitor 110 and fan telemetry monitor 114.

The validated ambient temperature is then sent by pattern-recognition mechanism 112 to controller 116. Then, based on the validated ambient temperature and information from fan telemetry monitor 114, controller 116 sets the fan speed for fan 104 and sends a fan speed control signal to fan 104. In some embodiments, controller 116 generates a control signal to assure stability of the fan speed by controlling the fan speed to increase or decrease without setting the absolute fan speed. In other embodiments, fan telemetry monitor 114 is not coupled to controller 116, and controller 116 assures stability of the fan speed by setting the fan speed based on the signal from pattern-recognition mechanism 112. In some embodiments, the control signal can include one or more control signals for each of one or more fans.

In some embodiments, pattern-recognition mechanism 112 sends the validated ambient temperature and a validated processor temperature to controller 116. The validated processor temperature is generated by pattern-recognition mechanism 112 from information including the signal from thermal telemetry monitor 110, and by using methods including detecting correlation patterns between and among performance parameters. In some of these embodiments, performance parameters of computer system 100 other than those discussed above, such as those set forth in U.S. Pat. No. 7,020,802, are gathered and sent to pattern-recognition mechanism 112. In some embodiments generating the validated processor temperature removes noise, including quantization noise, from the processor temperature signal.

In some embodiments, assuring stability of the fan speed includes, but is not limited to, reducing oscillations in the fan speed, and eliminating oscillations in the fan speed.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for assuring stability of a fan speed for each of one or more cooling fans in a computer system, comprising:
monitoring one or more temperatures of the computer system, an ambient temperature, and a current fan speed for each of the one or more cooling fans;
computing a validated ambient temperature based on parameters including the one or more temperatures of the computer system, the ambient temperature, and the current fan speed for each of the one or more cooling fans;
generating a control signal in response to the validated ambient temperature; and
sending the control signal to each of the one or more cooling fans to assure stability of the fan speed for each of the one or more cooling fans.

2. The method of claim 1, wherein computing the validated ambient temperature includes computing the validated ambient temperature based on parameters including a time series of the one or more temperatures of the computer system, and a time series of the ambient temperature.

3. The method of claim 2,
wherein monitoring the one or more temperatures of the computer system, the ambient temperature, and the current fan speed for each of the one or more cooling fans includes systematically monitoring and recording a set of performance parameters of the computer system; and
wherein the recording process keeps track of the temporal relationships between events in different performance parameters.

4. The method of claim 2, wherein computing the validated ambient temperature includes using a pattern-recognition technique.

5. The method of claim 1, wherein computing the validated ambient temperature includes using a nonlinear nonparametric regression technique.

6. The method of claim 5, wherein computing the validated ambient temperature includes using a multivariate state estimation technique.

7. The method of claim 1, wherein the method further comprises computing one or more validated temperatures of the computer system based on parameters including the one or more temperatures of the computer system, the ambient temperature, and the current fan speed for each of the one or more cooling fans; and
wherein generating the control signal includes generating the control signal in response to the one or more validated temperatures of the computer system.

8. The method of claim 1, wherein generating the control signal includes using a multiple input multiple output controller.

9. The method of claim 1, wherein generating the control signal includes using a dead-zone controller.

10. The method of claim 1, wherein generating the control signal includes generating the control signal in response to the current fan speed for each of the one or more cooling fans.

11. The method of claim 10 wherein generating the control signal includes generating a fan speed change signal for each of the one or more cooling fans based on parameters including the current fan speed for each of the one or more cooling fans.

12. A computer-readable storage medium storing instructions that when executed by a computer cause the computer to perform a method for assuring stability of a fan speed for each of one or more cooling fans in a computer system, the method comprising:
monitoring one or more temperatures of the computer system, an ambient temperature, and a current fan speed for each of the one or more cooling fans;
computing a validated ambient temperature based on parameters including the one or more temperatures of the computer system, the ambient temperature, and the current fan speed for each of the one or more cooling fans;
generating a control signal in response to the validated ambient temperature; and
sending the control signal to each of the one or more cooling fans to assure stability of the fan speed for each of the one or more cooling fans.

13. The computer-readable storage medium of claim 12, wherein computing the validated ambient temperature includes computing the validated ambient temperature based on parameters including a time series of the one or more temperatures of the computer system, and a time series of the ambient temperature.

14. The computer-readable storage medium of claim 13,
wherein monitoring the one or more temperatures of the computer system, the ambient temperature, and the current fan speed for each of the one or more cooling fans includes systematically monitoring and recording a set of performance parameters of the computer system; and
wherein the recording process keeps track of the temporal relationships between events in different performance parameters.

15. The computer-readable storage medium of claim 13, wherein computing the validated ambient temperature includes using a pattern-recognition technique.

16. The computer-readable storage medium of claim 12, wherein computing the validated ambient temperature includes using a nonlinear nonparametric regression technique.

17. The computer-readable storage medium of claim 16, wherein computing the validated ambient temperature includes using a multivariate state estimation technique.

18. The computer-readable storage medium of claim 12, wherein the method further comprises computing one or more validated temperatures of the computer system based on parameters including the one or more temperatures of the computer system, the ambient temperature, and the current fan speed for each of the one or more cooling fans; and
wherein generating the control signal includes generating the control signal in response to the one or more validated temperatures of the computer system.

19. The computer-readable storage medium of claim 12, wherein generating the control signal includes using a multiple input multiple output controller.

20. The computer-readable storage medium of claim 12, wherein generating the control signal includes using a dead-zone controller.

21. The computer-readable storage medium of claim 12, wherein generating the control signal includes generating the control signal in response to the current fan speed for each of the one or more cooling fans.

22. The computer-readable storage medium of claim 21 wherein generating the control signal includes generating a fan speed change signal for each of the one or more cooling fans based on parameters including the current fan speed for each of the one or more cooling fans.

23. An apparatus that assures stability of a fan speed for each of one or more cooling fans in a computer system, comprising:
a monitoring mechanism configured to monitor one or more temperatures of the computer system, an ambient temperature, and a current fan speed for each of the one or more cooling fans;
a computing mechanism configured to compute a validated ambient temperature based on parameters including a time series of the one or more temperatures of the computer system, a time series of the ambient temperature, and the current fan speed for each of the one or more cooling fans;
a generating mechanism configured to generate a control signal in response to the validated ambient temperature and the current fan speed for each of the one or more cooling fans; and
a sending mechanism configured to send the control signal to each of the one or more cooling fans to assure stability of the fan speed for each of the one or more cooling fans.

24. The apparatus of claim 23,
wherein the monitoring mechanism includes a mechanism configured to systematically monitor and record a set of performance parameters of the computer system; and
wherein the recording process keeps track of the temporal relationships between events in different performance parameters.

25. The apparatus of claim 23 wherein the computing mechanism includes a mechanism configured to use a multivariate state estimation technique.

26. The apparatus of claim 23 wherein the generating mechanism includes a mechanism configured to generating a fan speed change signal for each of the one or more cooling fans based on parameters including the current fan speed for each of the one or more cooling fans.
